(19) United States
(12) Patent Application Publication
(10) Pub. No.: US 2026/0017342 A1
(43) Pub. Date: Jan. 15, 2026

(54) MATRIX PRODUCT CALCULATOR

(71) Applicant: Fujitsu Limited, Kawasaki-shi (JP)

(72) Inventor: Hiroki TOKURA, Yokohama (JP)

(73) Assignee: Fujitsu Limited, Kawasaki-shi (JP)

(21) Appl. No.: 19/233,310

(22) Filed: Jun. 10, 2025

(30) Foreign Application Priority Data
Jul. 11, 2024 (JP) 2024-112015

(51) Int. Cl. G06F 17/16

(52) U.S. Cl. CPC G06F 17/16

(57) ABSTRACT

A matrix product calculator performs: in calculation of a matrix product using a first complex matrix, a second complex matrix, and a third complex matrix, separating a complex number included in the second complex matrix into a real part and an imaginary part, loading the real part and the imaginary part of the complex number into a plurality of calculator elements, performing first multiplication that multiplies the first complex matrix and the real part of the second complex matrix, and adding the third complex matrix to a result of the first multiplication, swapping the imaginary part with the real part in each complex number of the first complex matrix, and performing second multiplication that multiplies the imaginary part of the second complex matrix and the first complex matrix with the swapped parts, and adding the third complex matrix to a result of the second multiplication.

### CROSS-REFERENCE TO RELATED APPLICATION

This application is based upon and claims the benefit of priority of the prior Japanese Patent application No. 2024-112015, filed on Jul. 11, 2024, the entire contents of which are incorporated herein by reference.

### FIELD

The present embodiment relates to a matrix product calculator.

### BACKGROUND

In high performance computing (HPC), matrix product calculation is frequently used, and for example, a library that compiles a series of matrix product calculations such as basic linear algebra subprograms (BLAS) has been published. In addition, depending on an application, a matrix product for a complex matrix also needs to be used.

For example, a deep neural network (DNN) frequently uses a matrix product. Therefore, a system equipped with a matrix product calculator (accelerator) that accelerates matrix product calculation has been also known as a hardware configuration (for example, see Japanese National Publication of International Patent Application No. 2020-509501). Furthermore, in recent years, a layer using a complex number may be used in a DNN, and a complex matrix product also needs to be provided in artificial intelligence (AI).

Since the complex matrix product can be calculated by being replaced with a matrix product of real numbers, the complex matrix product can be calculated by a matrix product calculator of real numbers by replacing the complex matrix product with a real matrix product.

For example, related arts are disclosed in Japanese National Publication of International Patent Application No. 2020-509501, and US Patent Application Publication No. 2011/0040822.

### SUMMARY

According to an aspect of the embodiments, the matrix product calculator is a matrix product calculator including a memory and a plurality of calculator elements and being configured to perform a process including: in calculation of matrix product using a first complex matrix, a second complex matrix, and a third complex matrix, separating a complex number included in the second complex matrix into a real part and an imaginary part, loading the real part and the imaginary part of the complex number into the plurality of calculator elements, performing first multiplication that multiplies the first complex matrix and the real part of the second complex matrix, and addition that adds the third complex matrix to a result of the first multiplication, swapping the imaginary part with the real part in each complex number of the first complex matrix, and performing second multiplication that multiplies the imaginary part of the second complex matrix and the first complex matrix in which the imaginary part is swapped with the real part in the swapping, and addition that adds the third complex matrix to a result of the second multiplication.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing a configuration of an accelerator according to an embodiment;

FIG. 2 is a diagram for describing the configuration of the accelerator according to the embodiment;

FIG. 3 is a diagram for describing the size of a matrix;

FIG. 4 is a diagram illustrating a configuration of i-swap in the accelerator according to the embodiment;

FIG. 5 is a diagram for describing an operation of i-swap in the accelerator according to the embodiment;

FIG. 6 is a diagram illustrating a pseudo code representing the operation of i-swap in the accelerator according to the embodiment;

FIG. 7 is a flowchart for describing processing of a complex matrix product in the accelerator according to the embodiment;

FIG. 8 is a diagram illustrating complex matrices A, B, and C processed in the accelerator according to the embodiment;

FIG. 9 is a diagram illustrating the complex matrices A, B, and C processed in the accelerator according to the embodiment;

FIG. 10 is a diagram illustrating the complex matrices A, B, and C processed in the accelerator according to the embodiment;

FIG. 11 is a diagram illustrating the complex matrices A, B, and C processed in the accelerator according to the embodiment;

FIG. 12 is a diagram illustrating the complex matrices A, B, and C processed in the accelerator according to the embodiment;

FIG. 13 is a diagram illustrating the complex matrices A, B, and C processed in the accelerator according to the embodiment;

FIG. 14 is a diagram illustrating the complex matrices A, B, and C processed in the accelerator according to the embodiment;

FIG. 15 is a diagram illustrating the complex matrices A, B, and C processed in the accelerator according to the embodiment;

FIG. 16 is a diagram illustrating the complex matrices A, B, and C processed in the accelerator according to the embodiment;

FIG. 17 is a diagram illustrating a matrix product having a complex matrix size to be read of (128, 128, 128);

FIG. 18 is a diagram for describing a method of calculating a matrix product while moving a submatrix;

FIG. 19 is a diagram for describing the method of calculating the matrix product while moving the submatrix; and

FIG. 20 is a diagram for describing processing of a matrix A and a matrix B in the accelerator according to the embodiment.

### DESCRIPTION OF EMBODIMENT

A method of replacing a complex matrix product with a real matrix product has a problem of increasing costs due to occurrence of numerous rearrangements and additional memory requirements.

Hereinafter, an embodiment according to the present matrix product calculator will be described with reference to the drawings. However, the embodiments described below are merely examples, and there is no intention to exclude the application of various modifications and techniques that are not explicitly described in the embodiments. That is, the present embodiment can be variously modified and implemented without departing from the gist thereof. In addition, each drawing is not intended to include only the components illustrated in the drawing, but may include other functions and the like.

### (A) Configuration

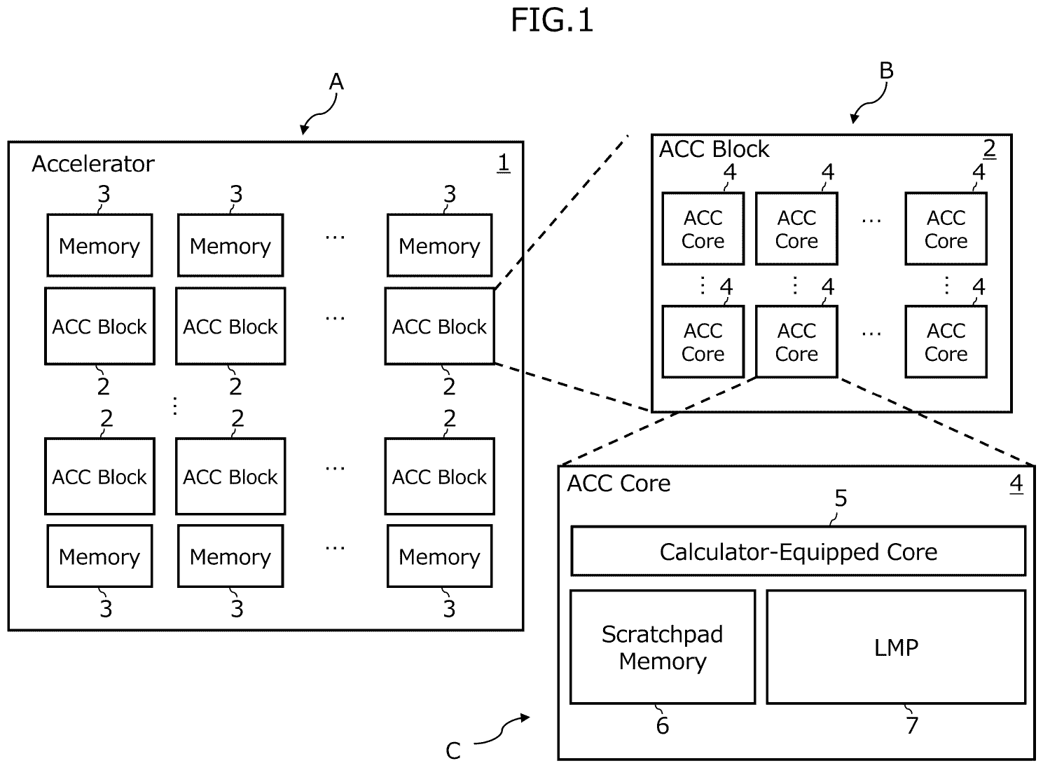

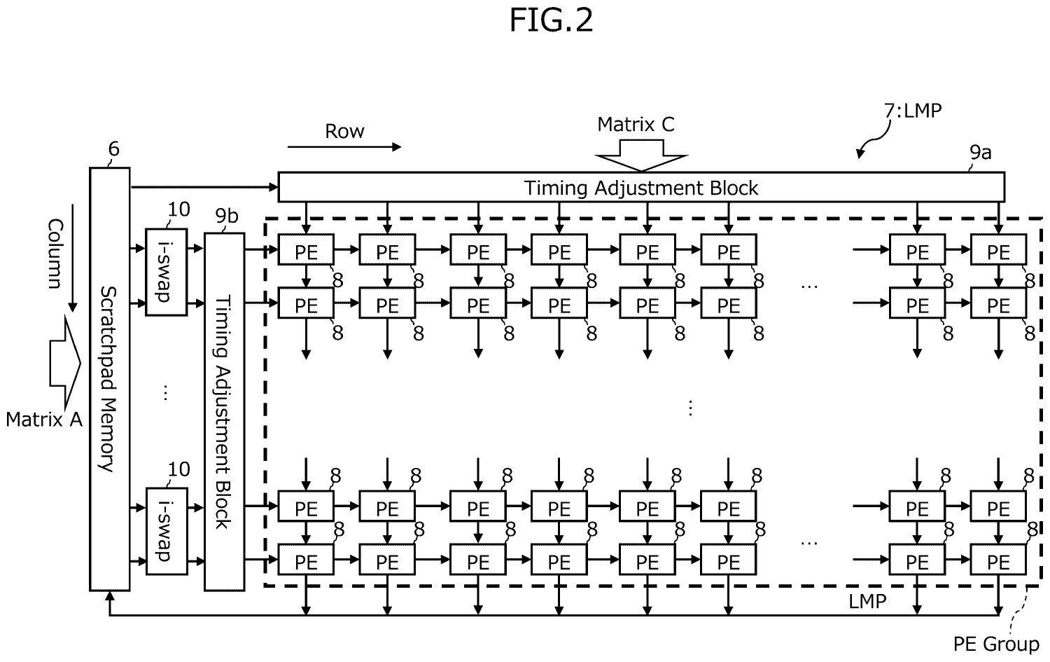

FIGS. 1 and 2 are diagrams for describing a configuration of an accelerator 1 according to an embodiment.

The accelerator 1 is a hardware accelerator having a function of performing matrix product calculation, and is mounted, for example, on an HPC.

In FIG. 1, a reference symbol A denotes a schematic configuration example of the accelerator 1. Further, a reference symbol B denotes a schematic configuration example of an ACC block 2 provided in the accelerator 1. A reference symbol C indicates a schematic configuration example of an ACC core 4 provided in the ACC block 2. In addition, FIG. 2 illustrates a schematic configuration example of a large matrix-multiplication processor (LMP) 7 provided in the ACC core 4.

As indicated by the reference symbol A in FIG. 1, the accelerator 1 includes multiple memories 3 and multiple ACC blocks 2. The memory 3 may be provided corresponding to the ACC block 2. In addition, the ACC block 2 includes multiple ACC cores 4, as indicated by the reference symbol B. Each of the ACC cores 4 includes a calculator-equipped core 5, a scratchpad memory 6, and the LMP 7, as indicated by the reference symbol C.

The accelerator 1 is an example of a matrix product calculator including the scratchpad memory 6 (memory) and multiple processing elements (PEs) 8 (calculator elements).

The calculator-equipped core 5 controls, for example, the execution of calculation of matrix product by the LMP 7 of the ACC core 4 on which the calculator-equipped core 5 is mounted. The calculator-equipped core 5 causes the LMP 7 of the ACC core 4 on which the calculator-equipped core 5 is mounted to perform the calculation of matrix product.

In the following example, an example of calculating the matrix product αA×B+βC will be described. The symbols a and B are scalars, and the symbols A, B, and C are matrices.

In the accelerator 1, the calculation of the complex matrix product can be realized, and the matrix product may be a complex matrix product. That is, each of the matrix A, the matrix B, and the matrix C may be a complex matrix. Hereinafter, the matrix A, which is a complex matrix, may be referred to as a complex matrix A. Similarly, the matrix B, which is a complex matrix, may be referred to as a complex matrix B, and matrix C, which is a complex matrix, may be referred to as a complex matrix C.

The complex matrix A is an example of a first complex matrix, and the complex matrix B is an example of a second complex matrix. The complex matrix C is an example of a third complex matrix.

The calculator-equipped core 5 can read and write data from and to the memory 3 and the scratchpad memory 6 of the ACC core 4 on which the calculator-equipped core 5 is mounted. The calculator-equipped core 5 can also know completion of calculation in the LMP 7 of the ACC core 4 on which the calculator-equipped core 5 is mounted.

In calculating the complex matrix product αA×B+βC, the calculator-equipped core 5 reads the complex matrix B from the memory 3, separates a real part and an imaginary part of each complex number included in the complex matrix B, and writes the separated real and imaginary parts to the scratchpad memory 6. The calculator-equipped core 5 then loads data of the real part and the imaginary part of the complex matrix B written to the scratchpad memory 6 into a register of the PE 8. Since the register of the PE 8 can store two pieces of data, the calculator-equipped core 5 stores the real part and the imaginary part of the complex number in the register of each PE 8. As a result, the real part and the imaginary part included in one element (complex number) constituting the complex matrix B are stored in one PE 8.

In addition, when calculating a complex matrix product, the calculator-equipped core 5 causes the multiple PEs 8 to calculate A×real part of B+C by using the real part of the complex matrix B, the complex matrix C, and the complex matrix A. In this calculation, the A×real part of B is an example of first multiplication.

Further, the calculator-equipped core 5 swaps the elements of the complex matrix A with the real part and the imaginary part by i-swap 10, inverts a sign of the imaginary part of the input, and outputs the sign-inverted imaginary part. Then, the calculator-equipped core 5 causes the multiple PEs 8 to perform the calculation of A×imaginary part of B+C using the imaginary part of the complex matrix B, the complex matrix C, and the complex matrix A. In this calculation, the A×imaginary part of B is an example of second multiplication.

The scratchpad memory 6 is a memory capable of high-speed data access, and may be disposed, for example, in the vicinity of a processor (not illustrated) of the HPC.

The scratchpad memory 6 stores (loads) therein data of the matrix A, the matrix B, and the matrix C that are input to the LMP 7 to be described later. As described later, the complex matrix B is rearranged on the scratchpad memory 6.

The LMP 7 has a two-dimensional systolic array configuration and performs calculation of a matrix product (αAB+βC).

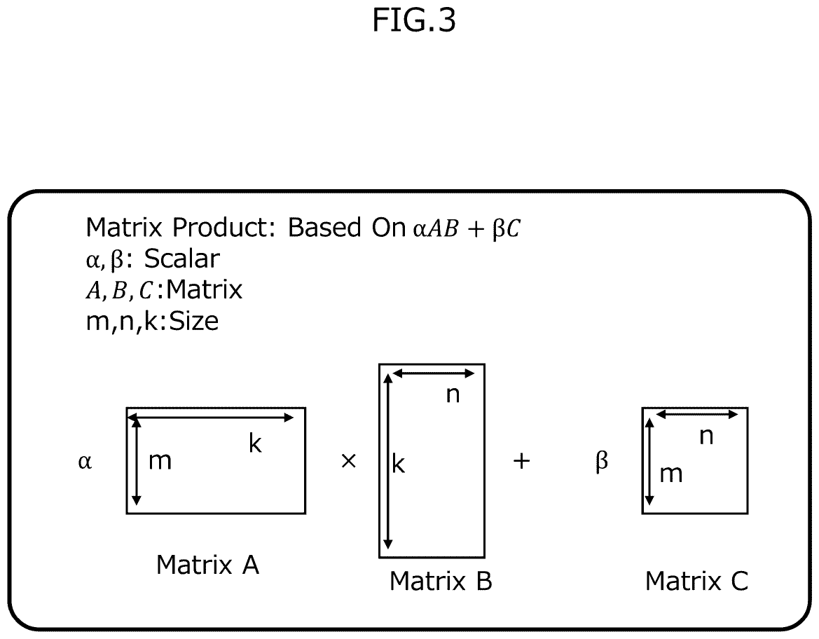

FIG. 3 is a diagram for describing the size of a matrix.

In FIG. 3, a matrix product αA×B+βC using the matrices A, B, and C is illustrated. For example, when the number of rows of the matrix A is represented by m, the number of columns of the matrix B is represented by n, and the number of rows of the matrix B is represented by k, the size of the matrix product may be represented as (m, n, k).

The LMP 7 is configured as, for example, a matrix product calculation unit that accelerates relatively large matrix product calculation such as (m, n, k)=(64, 64, 64). For reference, the size (matrix product size) of the conventional matrix product calculation unit used in DNN is (16, 16, 16) at most in the case of FP 16 (16-bit floating point numbers), and calculation is performed in a relatively small matrix product unit. Therefore, the LMP 7 having a relatively large matrix product size such as (m, n, k)=(64, 64, 64) may be regarded as a large matrix product calculation unit that accelerates a large matrix product. Further, the LMP 7 may be referred to as a matrix product engine.

The LMP 7 calculates a matrix product by using data of the scratchpad memory 6 of the ACC core 4 on which the LMP 7 is mounted. The LMP 7 performs a matrix product calculation in response to an instruction from the calculator-equipped core 5.

As illustrated in FIG. 2, the LMP 7 includes timing adjustment blocks 9a and 9b, multiple i-swaps 10, and multiple PEs 8.

The PE 8 is a calculator element that calculates the product-sum (a*b+c). In the LMP 7, the multiple PEs 8 are arranged in the row direction and the column direction by being arranged in a two-dimensional lattice pattern. In FIG. 2, the left-and-right arrangement of the multiple PEs 8 on the drawing surface corresponds to a row, and the upper-and-low bottom arrangement on the drawing surface corresponds to a column. The multiple PEs 8 arranged in the two-dimensional lattice pattern in the LMP 7 may be referred to as a PE group. In the present accelerator 1, the PE group is specialized in a real matrix product, and is configured to mount as many PEs 8 as possible so as to maximally preferable performance.

Each of the PEs 8 has a register capable of storing two elements (data). The data of the matrix B is stored in this register. More specifically, for the multiple complex numbers constituting the complex matrix B, the real part and the imaginary part obtained by separating one complex number are stored in the register of one PE 8.

In the multiple PEs 8 (PE group) arranged in the two-dimensional lattice shape, for example, a matrix A may be input from the left end of the two-dimensional lattice, while a matrix B may be input from the top end of the two-dimensional lattice, wherein each matrix A and B may be (submatrices) obtained by dividing respective original matrices.

The timing adjustment blocks 9a and 9b are hardware that adjusts the input timing of the matrix elements to the LMP 7.

The timing adjustment block 9a adjusts the input timing of the matrix C from the scratchpad memory 6 to the multiple PEs 8. The timing adjustment block 9a performs adjustment so that the elements constituting the matrix C are input at the same timing to the respective PE 8 constituting a head row (the uppermost row on the drawing in the example illustrated in FIG. 2) in the PE group.

The timing adjustment block 9b adjusts the input timing of the matrix A to the PE group. The timing adjustment block 9b performs adjustment so that the elements constituting the matrix A are input at the same timing to the respective PEs 8 constituting a head column (the leftmost column on the drawing surface in the example illustrated in FIG. 2) in the PE group.

The i-swap 10 implements swapping between the imaginary part and the real part of the complex number of the complex matrix A, and may be, for example, two-element input/output hardware. The i-swap 10 is disposed between the scratchpad memory 6 and the timing adjustment block 9b. The i-swap 10 may be controlled by the calculator-equipped core 5.

The imaginary part and the real part of the complex number of the complex matrix A and a flag (control signal) are input to the i-swap 10. For example, the real part is input to an input 0 of the i-swap 10, and the imaginary part is input to an input 1. When the real part and the imaginary part are swapped (for example, flag=1), the i-swap 10 outputs the imaginary part from an output 0 and outputs the real part from the output 1, respectively. On the other hand, when the real part and the imaginary part are not swapped (for example, flag=0), the i-swap 10 outputs the real part from the output 0 and outputs the imaginary part from the output 1, respectively.

The processing by the i-swap 10 may be regarded as equivalent to the processing of swapping the imaginary part and the real part of the complex number in the complex matrix A by multiplying each of the imaginary parts and the real parts of the complex matrix A with imaginary unit i.

The i-swap 10 is an example of a swapping unit configured to swap the imaginary part with the real part of each complex number in the complex matrix A (first complex matrix) by multiplying each of the real parts and the imaginary parts of the complex matrix A with the imaginary unit i.

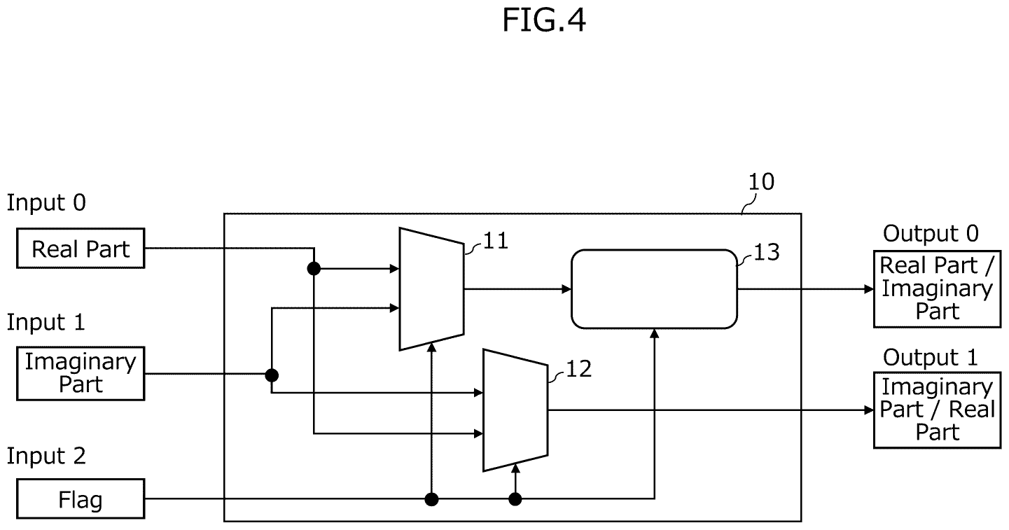

FIG. 4 is a diagram illustrating the configuration of the i-swap 10 in the accelerator 1 according to the embodiment.

The i-swap 10 illustrated in FIG. 4 includes two selectors 11 and 12 and a sign inversion block 13.

Each of the two selectors 11 and 12 has three input terminals and one output terminal. In accordance with a control signal (flag) input to one input terminal among the three input terminals, each of the selectors 11 and 12 outputs one of the signals input to the remaining two input terminals from the output terminal.

In the selectors 11 and 12 schematically illustrated using a trapezoid in FIG. 4, among the two input terminals disposed on the bottom surface of the trapezoid, the input terminal on the upper side of the drawing surface in FIG. 4 may be referred to as a first input terminal, and the input terminal on the lower side of the drawing surface may be referred to as a second input terminal. In addition, the input terminal disposed on the trapezoidal slope may be referred to as a third input terminal.

An input 0, an input 1, and an input 2 are input to each of the two selectors 11 and 12. The real part of the complex number of the complex matrix A is input to the input 0. The imaginary part of the complex number of the complex matrix A is input to the input 1. The flag (control signal) indicating whether to swap the real part with the imaginary part is input to the input 2.

In the selector 11, the input 0 is connected to the first input terminal, and the input 1 is connected to the second input terminal. Meanwhile, in the selector 12, the input 0 is connected to the second input terminal, and the input 1 is connected to the first input terminal. In each the selectors 11 and 12, the input 2 is connected to the third input terminal.

Furthermore, in any one of the selectors 11 and 12, when 0 is input as the flag (input 2), the input to the first input terminal (the input terminal on the upper side of the drawing surface) is selected as the output, and when 1 is input as the flag (input 2), the input to the second input terminal (the input terminal on the lower side of the drawing surface) is selected as the output.

The output of the selector 11 is input to the sign inversion block 13. When the real part and the imaginary part are swapped by the flag (for example, the flag=1), the sign inversion block 13 outputs one obtained by inverting the sign of the input value. In this way, inverting the sign of the input value is equivalent to multiplying the input value of the sign inversion block 13 by −1. As a result, it is possible to eliminate the influence of a negative sign on the PE group caused by the square of i.

On the other hand, when the real part and the imaginary part are not swapped by the flag (for example, flag=0), the sign inversion block 13 outputs the input value as it is. In this manner, outputting the input value as it is equivalent to multiplying the input value of the sign inversion block 13 by +1.

The output of the sign inversion block 13 is an output 0. The output of the selector 12 is an output 1. When viewed from the PE group, the output 0 appears to output the real part of the complex number, and the output 1 appears to output the imaginary part of the complex number.

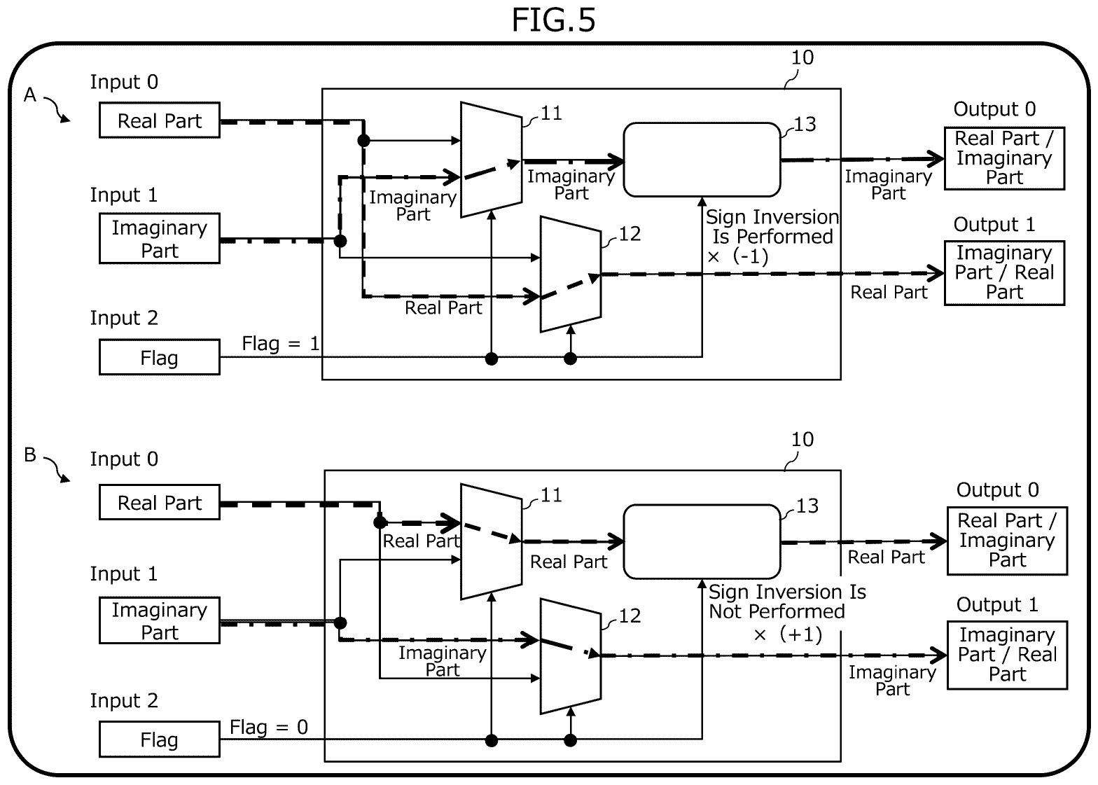

FIG. 5 is a diagram for describing the operation of the i-swap 10 in the accelerator 1 according to the embodiment. In FIG. 5, the reference symbol A indicates the operation of the i-swap 10 when the real part and the imaginary part are swapped (flag=1), and the reference symbol B indicates the operation of the i-swap 10 when the real part and the imaginary part are not swapped (flag=0). In FIG. 5, the flow of the value (real part) input from the input 0 is indicated by a broken line, and the flow of the value (imaginary part) input from the input 1 is indicated by a one-dot chain line.

As indicated by the reference symbol A, when the real part and the imaginary part are swapped (flag=1), flag=1 is input to each of the selectors 11 and 12 and the sign inversion block 13.

In the selector 11, the input of the second input terminal (the imaginary part of the input 1) is selected, and the imaginary part of the input 1 is output. The imaginary part of the input 1 output from the selector 11 is input to the sign inversion block 13. The sign inversion block 13 performs sign inversion on a value of the imaginary part of the input 1 (multiplies the imaginary part of the input 1 by −1). The sign inversion block 13 outputs a value (imaginary part) obtained by performing sign inversion on the value of the imaginary part of the input 1 (output 0).

Further, in the selector 12, the input of the second input terminal (the real part of the input 0) is selected, and the real part of the input 0 is output (output 1).

As indicated by the reference symbol B, when the real part and the imaginary part are not exchanged (flag=0), the flag=0 is input to each of the selectors 11 and 12 and the sign inversion block 13.

In the selector 11, the input of the first input terminal (the real part of the input 0) is selected, and the real part of the input 0 is output. The real part of the input 0 output from the selector 11 is input to the sign inversion block 13. The sign inversion block 13 outputs a value of the real part of the input 0 as it is (output 0).

In the selector 12, the input of the first input terminal (the imaginary part of the input 1) is selected, and the imaginary part of the input 1 is output (output 1).

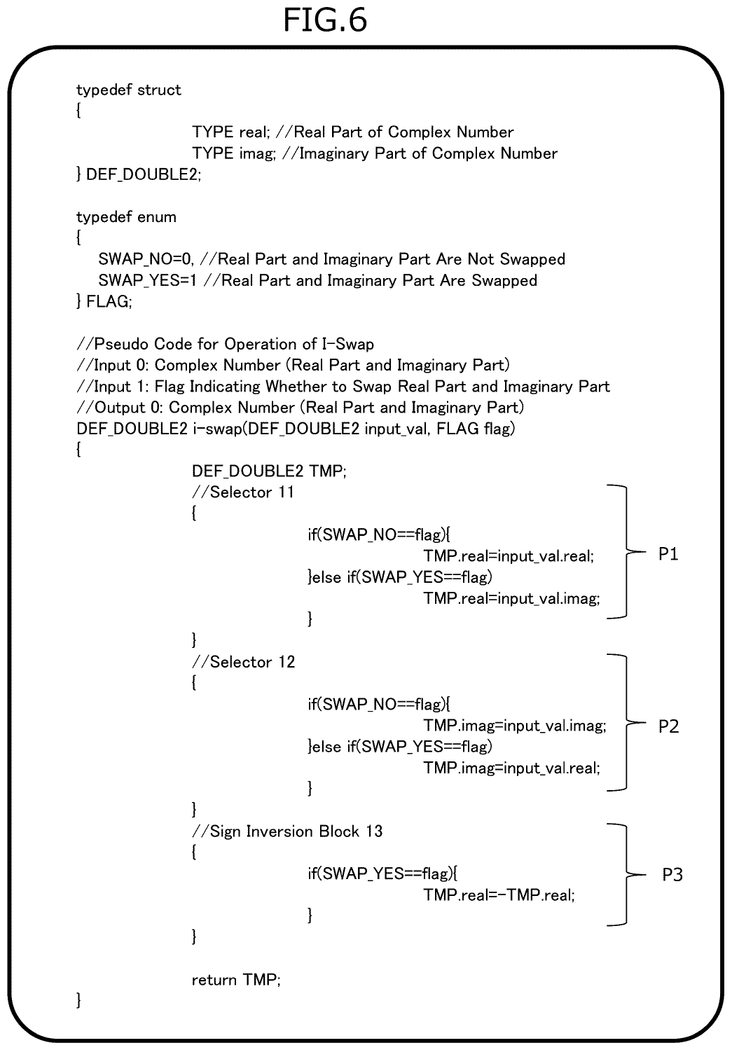

FIG. 6 is a diagram illustrating an example of a pseudo code representing the operation of the i-swap 10 in the accelerator 1 according to the embodiment.

In the pseudo code illustrated in FIG. 6, for example, it is specified that the selector 11 sets the value (input_val.real) of the real part of the input 0 to TMP.real in a case where the imaginary part and the real part are not swapped, and sets the value (input_val.imag) of the imaginary part of the input 1 to TMP.real in a case where the imaginary part and the real part are swapped (refer to a reference symbol P1).

Further, it is specified that the selector 12 sets the value of the imaginary part (input_val.imag) of the input 1 to TMP.imag in a case where the imaginary part and the real part are not swapped, and sets the value of the real part (input_val.real) of the input 0 to TMP.imag in a case where the imaginary part and the real part are swapped (refer to a reference symbol P2).

Further, it is specified that the sign inversion block 13 multiplies the value of TMP.real by −1 in a case where the imaginary part and the real part are swapped (refer to a reference symbol P3).

The description returns to the description using FIG. 2. In FIG. 2, an arrow connecting multiple PEs 8 to each other indicates a flow of data, and for example, data is transmitted to the next stage PE 8 for each clock.

For example, in each row, the data of the matrix A received from the head PE 8 is sequentially sent to the subsequent PEs 8 connected in cascade. Similarly, in each column, the data of the matrix C input from the head PE 8 is sequentially sent to the subsequent PEs 8 connected in cascade.

In each PE 8, a sum-of-multiplication calculation is performed using data a of the matrix A, data b of the matrix B, and data c of the matrix C. The calculation result may be accumulated in the immediate previous result.

In addition, the output (matrix C) from each of the PEs 8 constituting the last row (the lowermost row on the drawing surface in FIG. 2) may be input to the scratchpad memory 6 and may consequently overwrite the matrix C previously stored on the scratchpad memory 6.

### (B) Operation

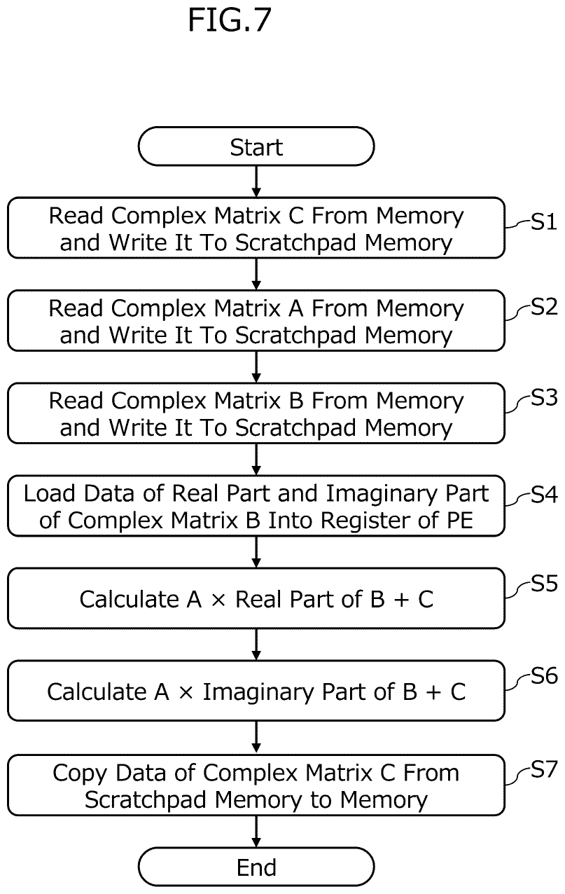

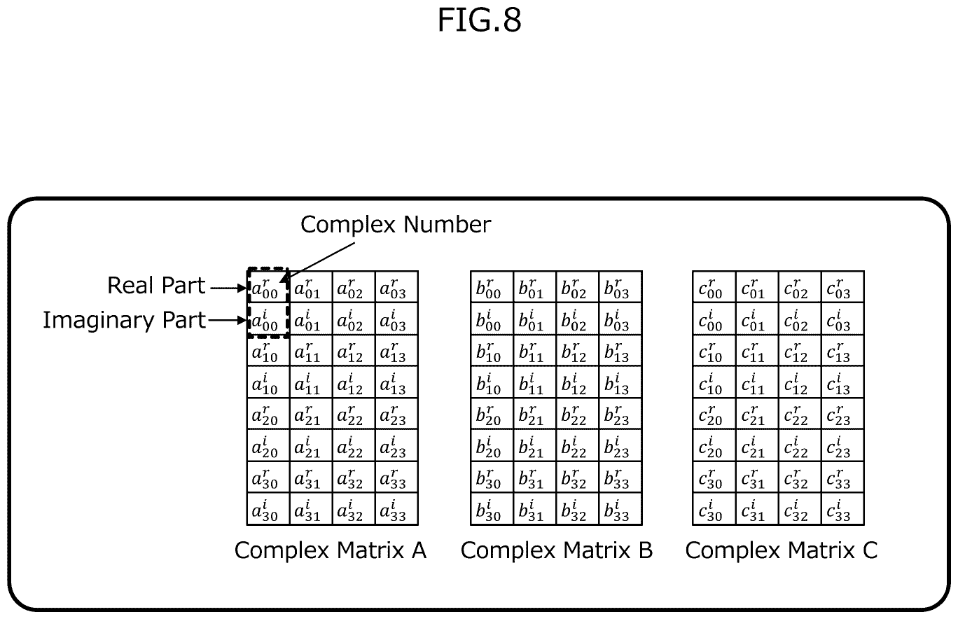

The processing of complex matrix product in the accelerator 1 according to the embodiment, which is configured as described above, will be described according to a flowchart (steps S1 to S7) illustrated in FIG. 7 with reference to FIGS. 8 to 16. FIGS. 8 to 16 are diagrams illustrating the complex matrices A, B, and C processed in the accelerator 1.

FIG. 8 illustrates the complex matrices A, B, and C input to the accelerator 1. Each of the complex matrices A, B, and C has multiple complex numbers. In addition, each of the complex numbers includes a real part and an imaginary part. These complex matrices A, B, and C are stored in the memory 3.

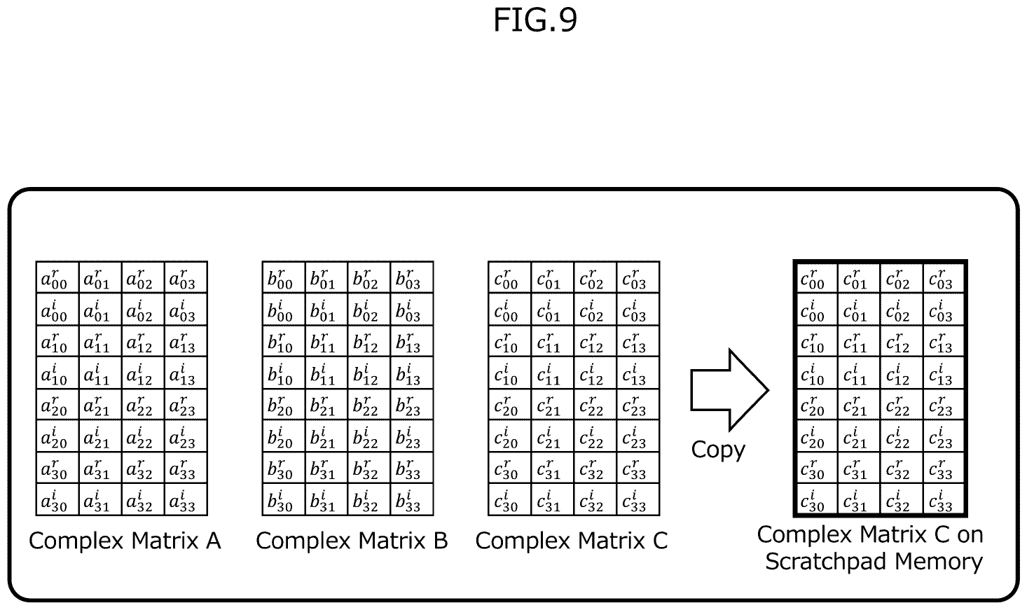

In step S1, the calculator-equipped core 5 reads the complex matrix C from the memory 3 and writes the read complex matrix C in the scratchpad memory 6 (refer to FIG. 9).

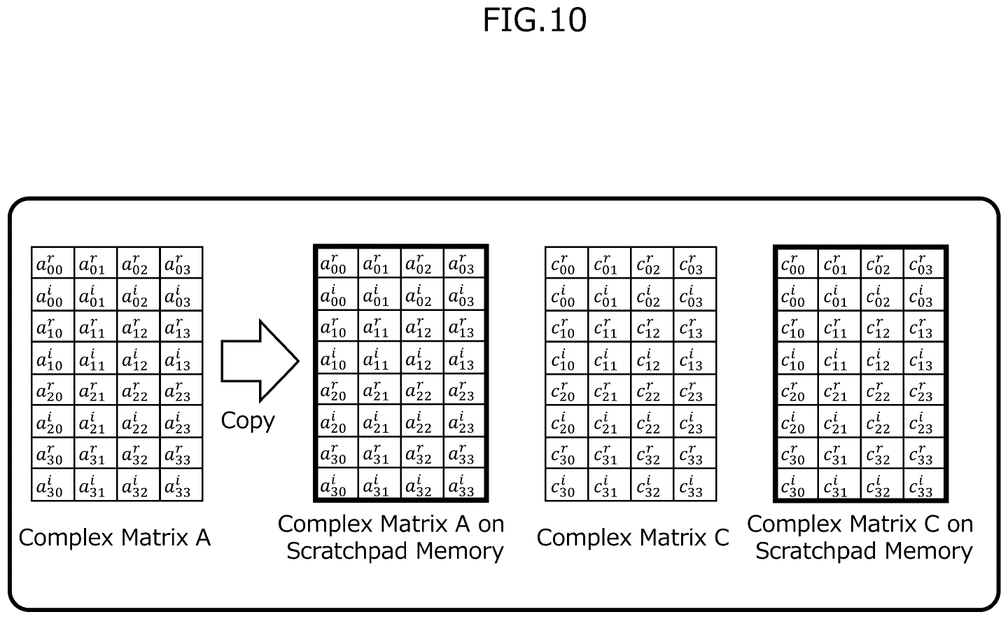

In step S2, the calculator-equipped core 5 reads the complex matrix A from the memory 3 and writes the read complex matrix A in the scratchpad memory 6 (refer to FIG. 10).

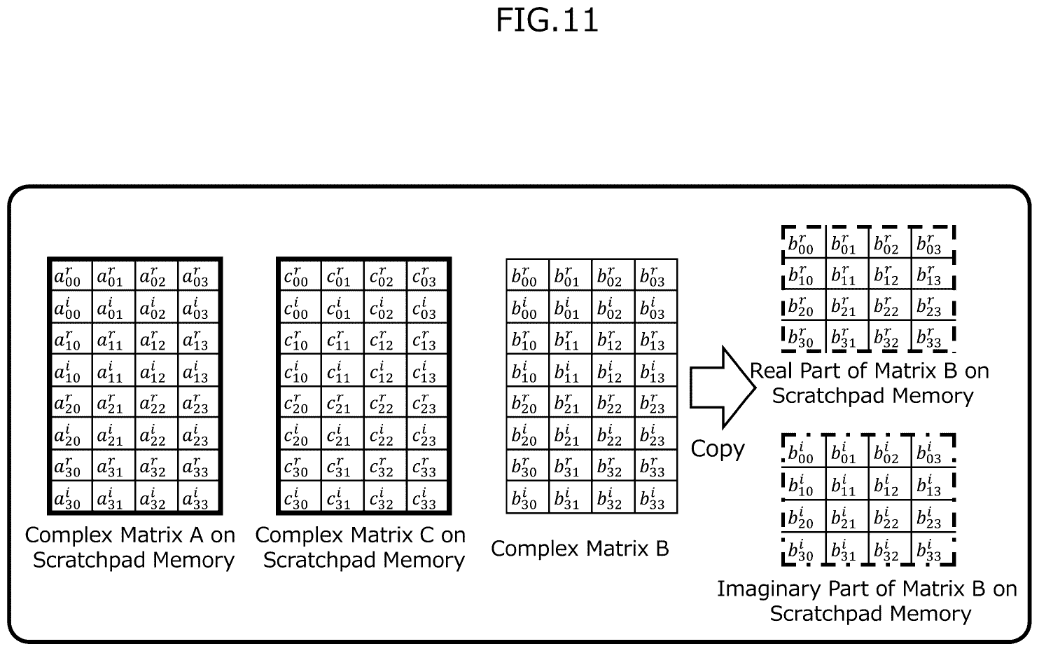

In step S3, the calculator-equipped core 5 reads the complex matrix B from the memory 3, separates the real part and imaginary part, and writes the separated real and imaginary parts in the scratchpad memory 6 (refer to FIG. 11).

It is noted that the order of steps S1 to S3 is not limited thereto, and the order may be changed, and at least some steps may be performed in parallel, and the steps may be performed with appropriate changes.

In step S4, the calculator-equipped core 5 loads the data of the real part and the imaginary part of the complex matrix B into the register of the PE 8.

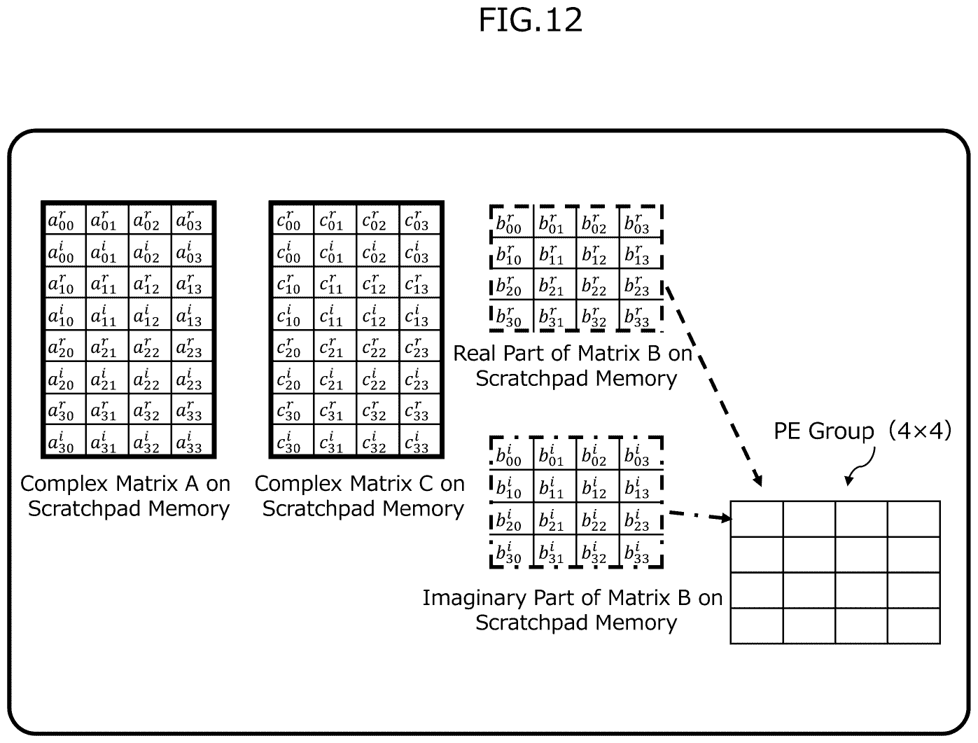

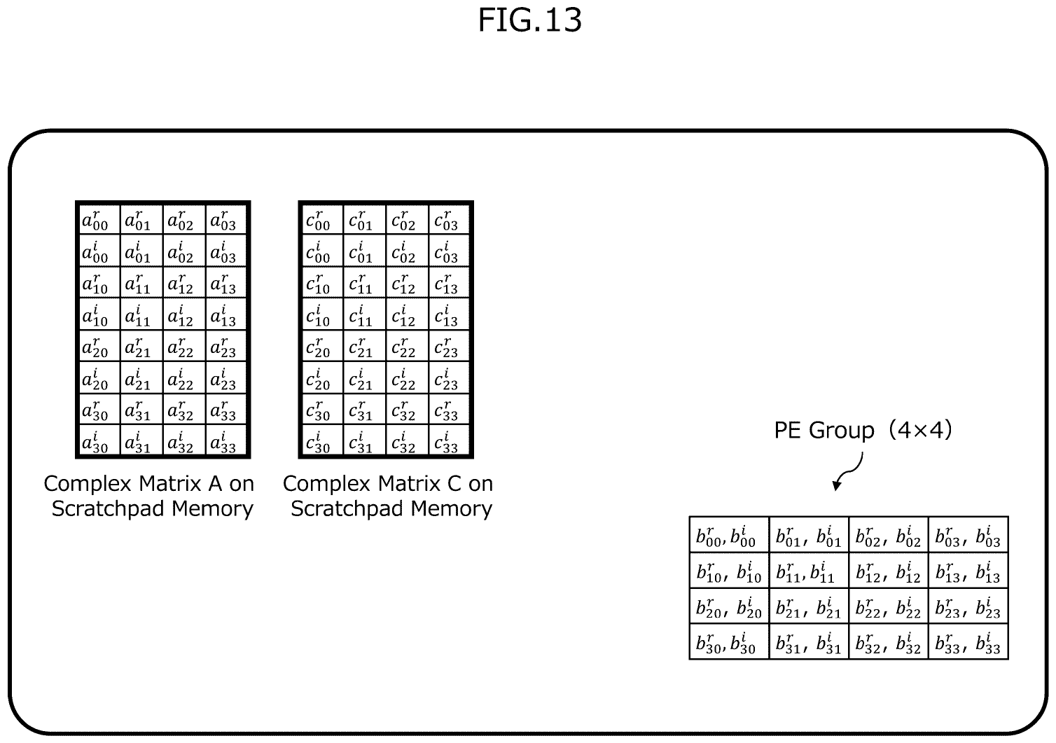

FIGS. 12 and 13 illustrate an example in which the real part and the imaginary part of the complex matrix B on the scratchpad memory 6 are loaded into 16 pieces of PE 8 (PE group) arranged in a 4×4 matrix, FIG. 12 illustrates a state of each register of the PE group before loading of the real and imaginary parts, and FIG. 13 illustrates a state of each register of the PE group after loading of the real and imaginary parts.

As illustrated in FIG. 13, the real part and the imaginary part of the complex number included in the complex matrix B are loaded into the register of each PE 8. As a result, the real parts and the imaginary parts of a corresponding complex numbers is stored in each of the PEs 8.

In step S5, the calculator-equipped core 5 multiplies the complex matrix A by the real part of the complex matrix B (first multiplication) and adds the complex matrix C thereto (A×real part of B+C).

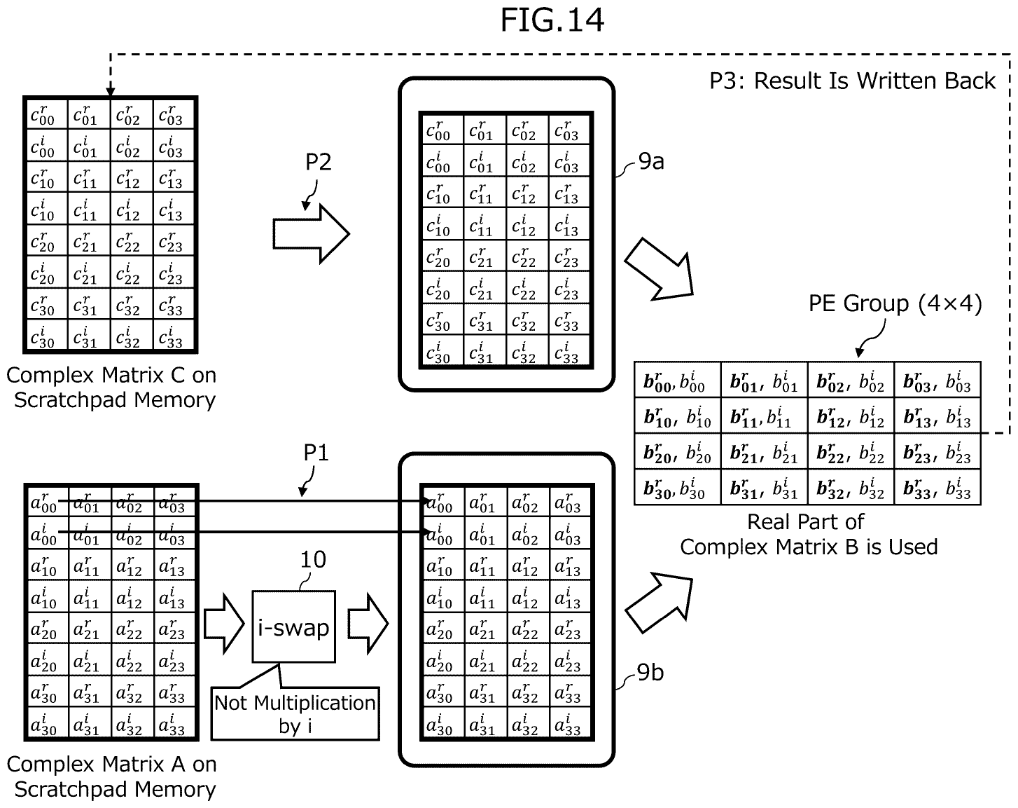

In this case, as illustrated in FIG. 14, the complex matrix A on the scratchpad memory 6 is read into the i-swap 10, and is stored as it is in the timing adjustment block 9b without being multiplied by i in the i-swap 10, that is, without swapping the real part with the imaginary part (refer to the reference symbol P1).

Further, the complex matrix C on the scratchpad memory 6 is stored in the timing adjustment block 9a (refer to the reference symbol P2).

Then, in the PE group, the real part of the complex matrix B, the complex matrix C in the timing adjustment block 9a, and the complex matrix A in the timing adjustment block 9b are used to calculate A×real part of B+C. This calculation result is written back to the complex matrix C of the scratchpad memory 6 (refer to the reference symbol P3).

In step S6, the calculator-equipped core 5 multiplies the complex matrix A by the imaginary part of the complex matrix B (second multiplication) and adds the matrix C thereto (A×imaginary part of B+C).

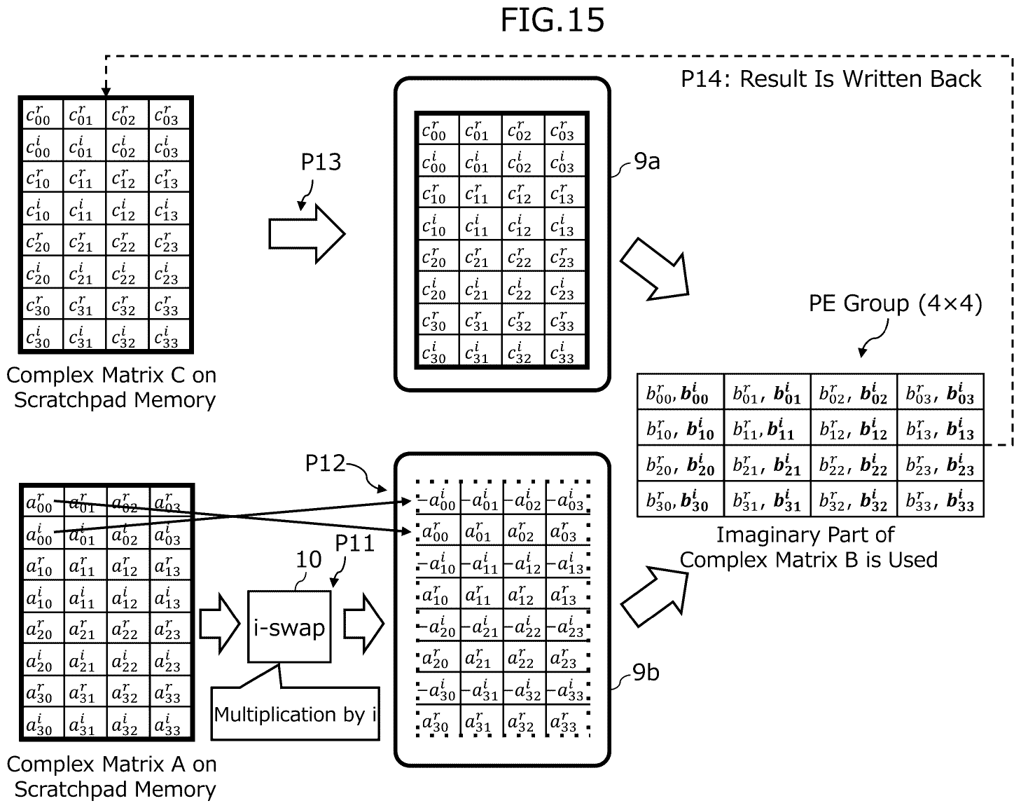

At this time, as illustrated in FIG. 15, the complex matrix A on the scratchpad memory 6 is read into the i-swap 10, multiplication is performed using i in the i-swap 10, and the real part and the imaginary part are swapped (refer to a reference symbol P11). A value of the matrix A, the imaginary part and the real part of which have been swapped by the i-swap 10, is stored in the timing adjustment block 9b (refer to a reference symbol P12).

Further, the complex matrix C on the scratchpad memory 6 is also stored in the timing adjustment block 9a (refer to a reference symbol P13).

Then, in the PE group, the imaginary part of the complex matrix B, the complex matrix C in the timing adjustment block 9a, and the complex matrix A in the timing adjustment block 9b are used to calculate A×imaginary part of B+C. This calculation result is written back to the complex matrix C of the scratchpad memory 6 (refer to a reference symbol P14).

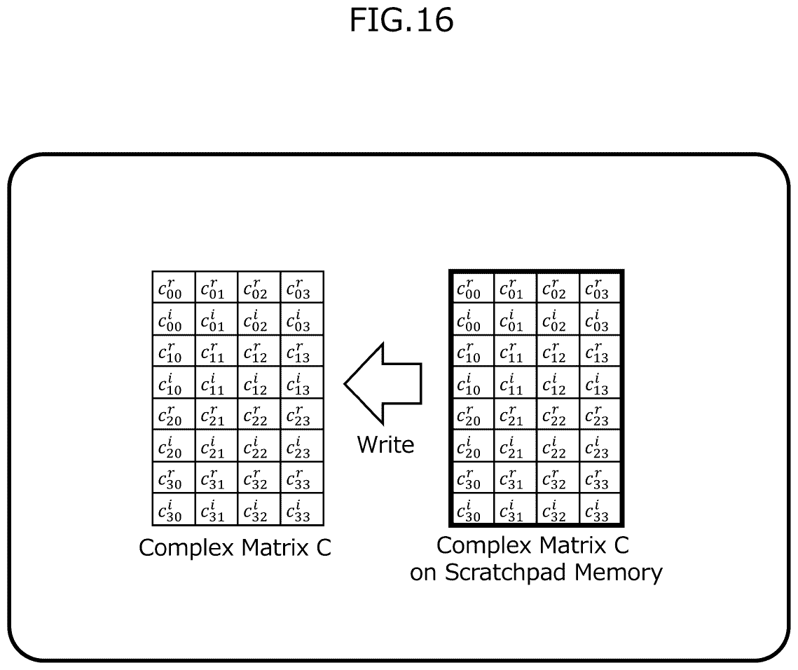

In step S7, the calculator-equipped core 5 copies the data of the matrix C overwritten and updated on the scratchpad memory 6 to the memory 3 as the complex matrix C (refer to FIG. 16). Thereafter, the processing ends.

In actual cases, there are cases in which complex matrix product calculation is performed with a size exceeding the size of the LMP 7 (LMP size).

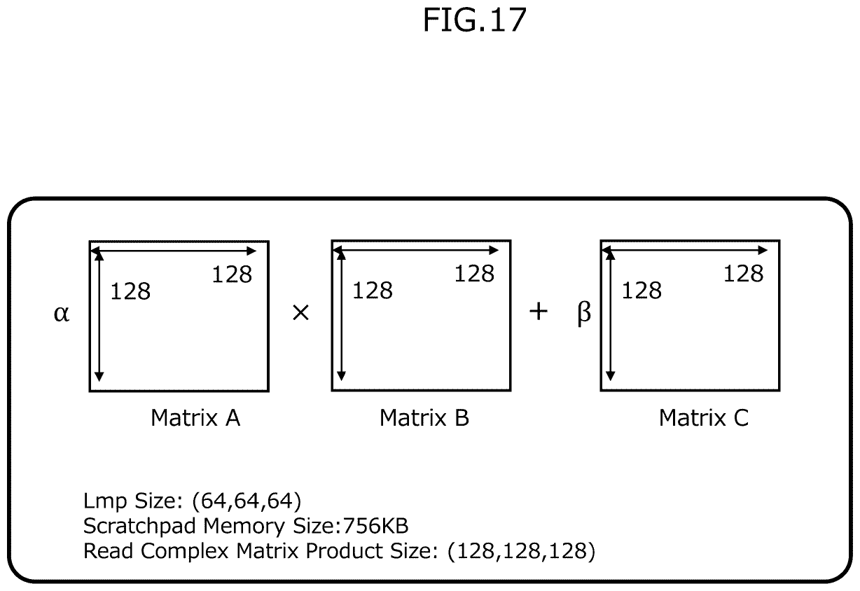

FIG. 17 illustrates a matrix product having a read complex matrix size of (128, 128, 128).

FIG. 17 illustrates an example in which the LMP size is (64, 64, 64), the size of the scratchpad memory 6 is 756 KB, and the size of the read complex matrix is (128, 128, 128).

In such a case, for example, the complex matrix C may be fixed, and the complex matrices A and B may be moved. The moving complex matrices A and B represent calculation of matrix product while shifting submatrices of the complex matrices A and B, which are to be calculated, one by one in the inner product direction.

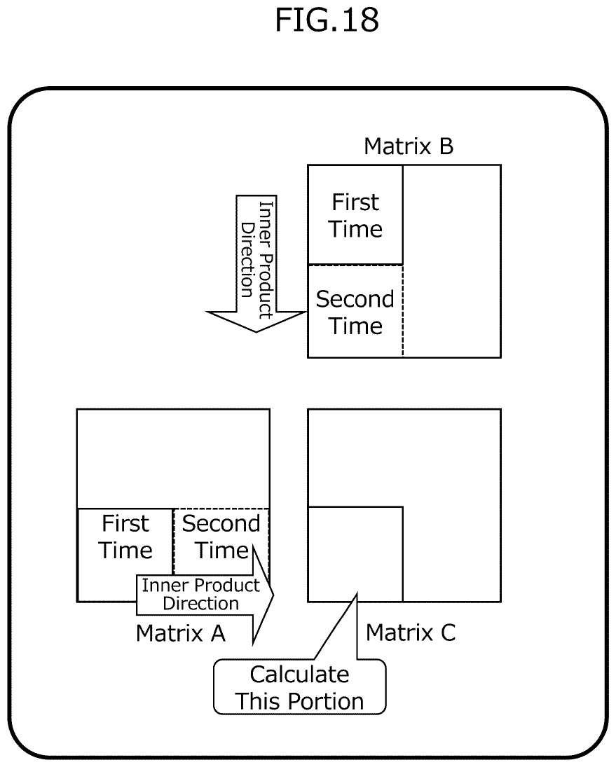

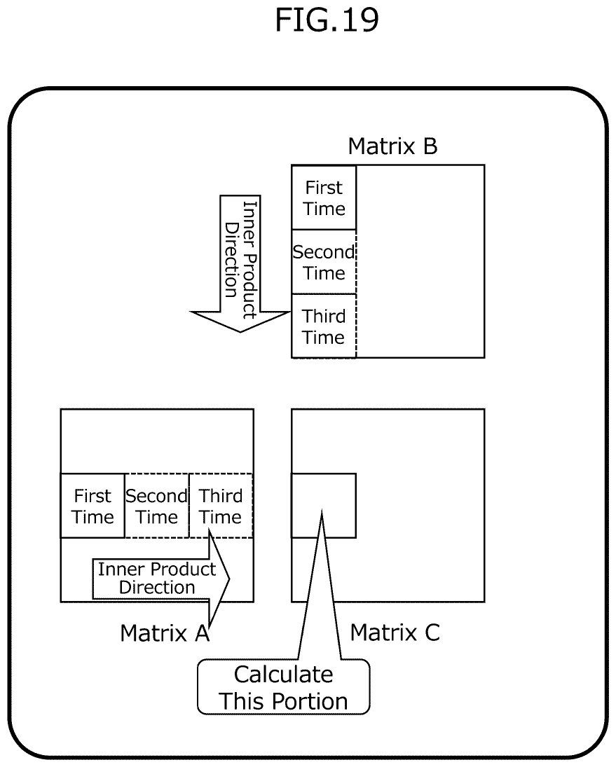

FIGS. 18 and 19 are diagrams for describing a method of calculating the matrix product while moving the submatrices (complex matrices). FIG. 18 illustrates an example in which the matrix A and the matrix B are divided into 2×2 submatrices to calculate the matrix C, and FIG. 19 illustrates an example in which the matrix A and the matrix B are divided into 3×3 submatrices to calculate the matrix C.

The submatrix product of the submatrix of the matrix A and the submatrix of the matrix B are calculated while the submatrix to be calculated is moved, and the sum of these submatrix products is obtained, thereby making it possible to obtain the matrix C.

### (C) Effects

In the accelerator 1 configured as described above, the calculator-equipped core 5 reads, when calculating the matrix product αA×B+βC using the complex matrices A, B, and C, the complex matrix B from the memory 3, separates the real part and the imaginary part, and writes the separated real and imaginary parts in the scratchpad memory 6. Then, the calculator-equipped core 5 loads the data of the real part and the imaginary part of the complex matrix B written in the scratchpad memory 6 into the register of the PE 8. At this time, the calculator-equipped core 5 stores the real part and the imaginary part in the register of each PE 8.

At this time, in the scratchpad memory 6, only an area of the same size as the elements of the read complex matrix is used. Accordingly, for example, as compared with the conventional method (for example, M1 algorithm) in which a value obtained by multiplying each element of the complex matrix A by i is added to the adjacent column to perform DGEMM (double-precision matrix product), the use size of the scratchpad memory 6 can be fixed and the use size can be reduced.

In addition, in the scratchpad memory 6, rearrangement of the matrix elements only needs to be performed for the complex matrix B, and the number of elements to be rearranged can be reduced. Furthermore, since the waiting time of the LMP 7 is reduced by reducing the number of times of rearrangements, the matrix product size per one time can be increased. For example, a large (large number of PEs 8) LMP 7 capable of processing a large matrix product such as (64, 64, 64) can be mounted, and a large matrix (complex matrix) capable of exhibiting the performance of the large LMP 7 can be processed. As a result, the complex matrix product can be calculated at low cost.

In addition, since the waiting time of the LMP 7 is reduced by reducing the rearrangement of the matrix elements, a larger LMP 7 can be mounted. The larger LMP 7 generally provides higher hardware implementation efficiency and better performance than smaller LMPs.

The matrix product generally performs multistage blocking, and the matrix B can be reused in the registers of the PE 8 and the scratchpad memory 6, so the cost of rearrangement appears to be relatively small. For example, in the sve command (supported by a64fx or the like) of arm, a value in a memory such as a high bandwidth memory (HBM) can be read while separating a real part and an imaginary part by a command such as ld2. The read value can be written directly to the scratchpad memory 6, so there is no particular overhead for the matrix B.

In addition, each complex number included in the complex matrix B is separated into a real part and an imaginary part. Then, the calculator-equipped core 5 loads the data of the real part and the imaginary part of each complex number into the register of the PE 8. As a result, the real parts and the imaginary parts of a corresponding complex numbers is stored in each of the PEs 8.

In addition, the calculator-equipped core 5 causes the LMP 7 to perform multiplication of the matrix A and the real part of the matrix B and addition of the matrix C (A×real part of B+C). Furthermore, the calculator-equipped core 5 causes the LMP 7 to perform multiplication of the imaginary part of the matrix B by the matrix A in which the imaginary part and the real part are swapped, and addition of the matrix C (A×imaginary part of B+C). By dividing the matrix B into the real part and the imaginary part, calculation can be performed on the reduced number of elements to be rearranged when complex matrix product is performed.

Further, by using the i-swap 10 configured to swap the imaginary part and the real part of the complex matrix A, complex matrix product can be efficiently calculated, and the cost of rearranging the elements of the complex matrix A can be reduced. Furthermore, rearrangement of the matrix A can be eliminated by using the i-swap 10.

In addition, since calculation can be performed while treating the real part and the imaginary part of the matrix A as they are, the number of rearrangement elements slightly increases, but for example, the real matrix product size per one time can be increased as compared with the known 4M algorithm.

Furthermore, the matrix product size per one time can be increased in the present accelerator 1 as compared with the known 4M algorithm. In addition, even if the real matrix product size is increased, the capacity of the scratchpad memory 6 equal to or more than the capacity of the scratchpad memory 6 from which the matrices A, B, and C are read is not used. Therefore, the capacity of the scratchpad memory 6 can be reduced and costs can be reduced as compared with the known 1M algorithm.

The i-swap 10 performs processing corresponding to the square of i outside the PE group, so that the PE array (PE group) itself can be configured using a real matrix product as it is. Furthermore, the i-swap 10 performs processing corresponding to the square of i outside the PE group, so that flag propagation does not need to be performed in the PE group, and circuit mounting costs can be reduced.

Further, in the present accelerator 1, the multiplication of the matrix A and the real part of the matrix B and the addition of the matrix C are performed (A×real part of B+C), and the multiplication of the matrix A in which the imaginary part and the real part are swapped and the imaginary part of the matrix B and the addition of the matrix C are performed (A×imaginary part of B+C).

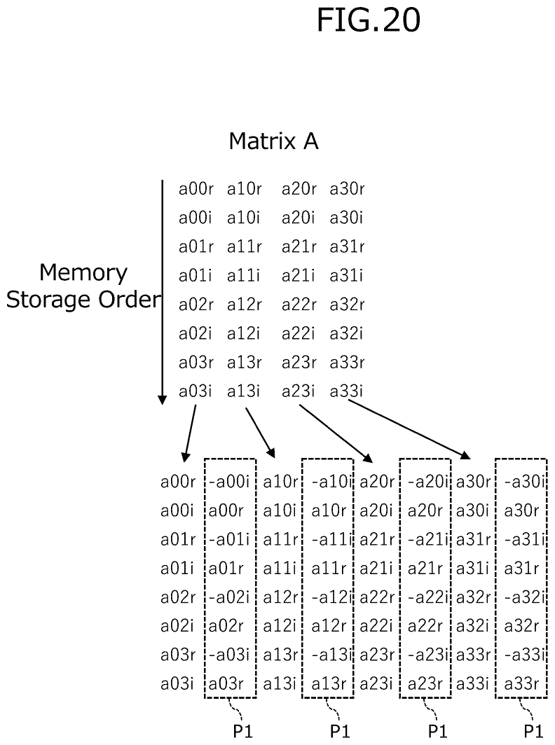

FIG. 20 is a diagram for describing the processing of the matrices A and B in the accelerator 1 according to the embodiment.

In FIG. 20, the columns enclosed by solid frames represent elements obtained by multiplying respective corresponding elements the matrix A on the left thereof with the imaginary unit i (see the reference symbol P1). A matrix product of the matrix A and the matrix B after such rearrangement is considered.

Here, in a case where the complex number A=aᵣ+jaᵢ and the complex number B=bᵣ+jbᵢ, the product (A×B) of the complex numbers can be calculated as follows. For easy distinction, an imaginary unit is defined as j.

The matrix product can be decomposed to the product of each element. By focusing on the calculation of one element, the matrix product A×B can be calculated by the following expression.

$$\begin{matrix}( {a}_{r} + {ja}_{i} ) \times ( {b}_{r} + {jb}_{i} ) = ( {a}_{r} + {ja}_{i} ) \times {b}_{r} + ( {a}_{r} + {ja}_{i} ) \times {jb}_{i} \\ = ( {a}_{r} {b}_{r} + {ja}_{i} {b}_{r} ) + ( {ja}_{r} {b}_{i} + {j}^{2} {a}_{i} {b}_{i} ) \\ = ( {a}_{r} {b}_{r} - {a}_{i} {b}_{i} ) + ( {a}_{r} {b}_{r} + {a}_{r} {b}_{i} ) j\end{matrix} \qquad ( 1 )$$

By focusing on the above Equation (1), it can be seen that the multiplication (aᵣbᵣ, aᵣbᵣ) of the matrix A and the real part of the matrix B, and multiplication (aᵣbᵢ, aᵢbᵢ) of the matrix A in which the imaginary part and the real part are swapped and the imaginary part of the matrix B are included.

As a result, the product of the complex matrices A and B can be calculated by the first calculation (A×real part of B+C) including the multiplication of the matrix A and the real part of the matrix B and the addition of the matrix C, the second calculation (A×imaginary part of B+C) including the multiplication of the matrix A in which the imaginary part and the real part are swapped and the imaginary part of the matrix B and the addition of the matrix C.

Furthermore, in the present accelerator 1, the multiplication of the matrix A and the real part of the matrix B and the addition of the matrix C are performed (A×real part of B+C), and the multiplication of the matrix A in which the imaginary part and the real part are swapped and the imaginary part of the matrix B and the addition of the matrix C are performed (A×imaginary part of B+C), so that only the matrix B can be rearranged. In addition, the size of the matrix product that can be performed at a time can be made larger than that of the 4M algorithm.

### (D) Others

The disclosed technology is not limited to the above-described embodiments, and various modifications can be made without departing from the gist of the present embodiment.

For example, in the above-described embodiment, the accelerator 1 may perform calculation of a real matrix product. In such calculation of the real matrix product, in the i-swap 10, a flag that does not swap the real part with the imaginary part is set (for example, flag=0), and then calculation of the real matrix product similar to that of the known accelerator may be performed.

In the above-described embodiment, for convenience, an example in which each LMP 7 has a two-dimensional structure in which one row and one column are processed in each PE 8 is illustrated, but the present embodiment is not limited thereto.

In addition, each configuration and each process of the present embodiment can be selected as needed, or may be appropriately combined.

Furthermore, according to the disclosure described above, the present embodiment can be carried out and manufactured by those skilled in the art.

According to an embodiment, a complex matrix product can be calculated at low cost.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A matrix product calculator comprising a memory and a plurality of calculator elements and being configured to perform a process comprising:
in calculation of matrix product using a first complex matrix, a second complex matrix, and a third complex matrix,
separating a complex number included in the second complex matrix into a real part and an imaginary part,
loading the real part and the imaginary part of the complex number into the plurality of calculator elements,
performing first multiplication that multiplies the first complex matrix and the real part of the second complex matrix, and addition that adds the third complex matrix to a result of the first multiplication,
swapping the imaginary part with the real part in each complex number of the first complex matrix, and
performing second multiplication that multiplies the imaginary part of the second complex matrix and the first complex matrix in which the imaginary part is swapped with the real part in the swapping, and addition that adds the third complex matrix to a result of the second multiplication.

2. The matrix product calculator according to claim 1, further comprising
a swapping unit configured to swap the imaginary part with the real part of each complex number of the first complex matrix by multiplying each of the real part and the imaginary part of the first complex matrix with an imaginary unit i.
